(19) United States
(12) Patent Application Publication
(10) Pub. No.: US 2011/0055154 A1
(43) Pub. Date: Mar. 3, 2011

(54) DUAL-SYNCHRONISATION METHOD FOR A MOBILE ELECTRONIC DEVICE

(75) Inventors: Benoit Gantaume, Marseille (FR); Lucas Leonardi, Marseille (FR)

(73) Assignee: DMAILER, Marseille (FR)

(21) Appl. No.: 12/860,018

(22) Filed: Aug. 20, 2010

(30) Foreign Application Priority Data
Aug. 27, 2009 (FR) 0955852

(51) Int. Cl. G06F 17/00

(52) U.S. Cl. 707/623; 707/E17.005; 707/E17.032

(57) ABSTRACT

The invention relates to a method of synchronizing data stored in a mobile device able to store data and to use it with proprietary client software, with data stored in a local terminal for the requirements of local software, in which local terminal it is identified by local identifiers, and with data stored in a server in which the data is associated with two types of identifier: local identifiers and network identifiers, the local terminal and the server being able to communicate to synchronize data stored in the local terminal with data stored in the server using the local identifiers, the method enabling the mobile device to change the mode of synchronization with the local terminal or with the server as a function of the connections available.

### BACKGROUND OF THE INVENTION

The present invention relates to the general field of methods of synchronizing data stored in a mobile electronic device able to store data and to use it with proprietary client software. Such a device may be a USB key, a personal digital assistant (PDA), etc.

Data synchronization is a function of electronic devices whereby at least two sets of data are made similar to each other so that the sets of data substantially match each other once synchronization has been effected.

This function is routinely used at present between mobile devices and local terminals connected to servers. However, the proliferation of mobile devices liable to be used by the same user means that at present requirements relating to data synchronization have increased. In particular, there is a major requirement to be able to synchronize data reliably between more than two electronic devices.

It is relatively routine at present for a person working in a business environment to have to access their own data from at least three devices: a personal local terminal, a server accessible via the Internet, and a mobile device.

The data to be synchronized in this context is generally personal information data such as e-mails, contacts, and a calendar.

Using proprietary client software in the mobile device typically makes it possible to use data shared with local software installed on a local terminal. Clearly such data must therefore be synchronized effectively.

Thus, to be more precise, the invention relates to synchronizing data stored in a mobile device with data stored in a local terminal for the requirements of local software executed in the local terminal, when it must also be possible for such synchronization to be effected with data stored in a remote server.

In the context of the invention, the local terminal and the server are able to communicate with each other to synchronize data stored in the local terminal for the requirements of the local software and data stored in the server in relation to the operation of the local software, typically messaging, contact management, calendar, etc.

All elements stored on the server have two types of identifier. Each of these identifiers makes it possible to communicate with the server using two different protocols, a local protocol with which local identifiers are used and a network or remote protocol with which network identifiers are used.

The local protocol typically makes it possible to synchronize local software, for example Outlook, in a local terminal with an Exchange server on the business local area network.

The remote or network protocol typically makes it possible to consult e-mails via a browser. The functions that provide access to data stored on the server typically use as parameters only network identifiers. In contrast, it should be noted that these access functions make it possible to provide the two types of identifier, which in turn makes it possible to obtain a local identifier directly when reading the corresponding data.

Each of these protocols works only with the type of identifier that it knows. The local software installed in the local terminal, for example Outlook, typically knows only local identifiers. Thus local identifiers are incompatible with network identifiers. It is therefore impossible to mix the two synchronization modes.

For synchronization between the local terminal and the server, data is communicated between the server and the local terminal using local identifiers. Thus the identifiers manipulated by the local software and stored in the local terminal are local identifiers generated by the server for the requirements of communication with the local terminal. Such use of the local software/server pair is routine in messaging software or more generally in office software of the Outlook, etc. type.

As already noted, it is found that synchronization using the network protocol requires the use of different type identifiers. Thus local identifiers are incompatible with identifiers used to synchronize the mobile device with the server, i.e. network identifiers.

There nevertheless exist at present a plurality of ways to synchronize data present in the above three devices.

FIG. 1 shows a first architecture centered on a server 120 able to offer collaborative services such as e-mails, an address book or a calendar.

In this architecture, the server 120 communicates with a local terminal 110 equipped with the local software. The server 120 also communicates with a mobile device 130 able to connect directly to the server 120.

This architecture enables the local terminal 110 and the mobile device 130 to synchronize their data with data stored in the server 120.

In this architecture, synchronization of the local terminal and synchronization of the mobile device are independent. Synchronization of the local terminal 110 uses local identifiers and synchronization of the mobile device 130 uses network identifiers.

If a connection to the local terminal is effected using the mobile device, only the resources for connecting the local terminal 110 and the server 120 are used by the mobile device 130 to synchronize its data with only data present in the server 120 using network identifiers. In this architecture, the mobile device 130 never synchronizes its data directly with data in the local terminal 110 identified by local identifiers. In this architecture, the server 120 is at the center of all data transfers.

The great advantage of this architecture is that data may be synchronized in real time in the mobile device 130. Furthermore, the dialogue between the mobile device 130 and the server 120 is such that the server sends only recent new data to the mobile device 130.

This architecture has disadvantages, however, because the amount of data present in the mobile device 130 must be limited. Mobile devices are generally limited in terms of memory and there is a great difference between the memory capacity of the mobile devices and the memory capacity of the local terminals.

The amount of data that can be stored in the mobile devices is also limited because of the slowness of synchronization effected via a wireless connection. With a wireless connection, the bandwidth is limited to the bandwidth available on the wireless network at the time. Thus synchronizing a standard mailbox of around one gigabyte can take hours.

The slowness of synchronization also causes problems in terms of the costs associated with synchronization because some mobile devices connect to a service that may be billed on the basis of use. Thus the greater the quantity of data synchronized, the higher the cost of synchronization.

Nevertheless, numerous synchronization services operate on the basis of this architecture including three different devices with three different software packages in each device.

For example, the sets of three different software packages might be as follows:
Outlook/Exchange/Windows Mobile
Outlook/Exchange/iPhone
Outlook/Exchange/Blackberry or as follows:
AppleMail/MobileMe/iPhone
Lotus Notes/Exchange/(Windows Mobile or iPhone or Blackberry)
Lotus Notes/Lotus Server/proprietary client software for mobiles.

In the first architecture examples, Outlook is the local software executed in the local terminal, Exchange is the software for processing data in the server, and Windows Mobile, iPhone or Blackberry incorporate proprietary client software for synchronizing the data with all the data present in the server.

Note here that communication between the local software, for example Outlook, and the server uses local identifiers when data is sent to and stored in the local terminal 110.

Given that communication between the proprietary client software executed in the mobile device 30 and that executed in the server 120 does not entail any change of identifier and therefore uses the network identifiers, it is not at present possible to synchronize data directly between a local terminal 110 and a mobile terminal 130 that synchronizes its data directly with the server 120.

FIG. 2 shows another architecture centered on a local terminal 110. Here the local terminal 110 is able to connect to a server 120 to synchronize with all the data stored in the server 120.

In this architecture, the mobile device 130 may be connected directly to the local terminal 110 by a local connection which it uses to synchronize its data with data stored in the local terminal. This local connection is generally made via a serial (e.g. USB) cable. In this architecture, the local terminal 110 centralizes data transfer.

In this architecture, the local terminal 110 synchronizes its own data with the server 120 before the mobile device 130 is able to synchronize its data with the data stored in the local terminal 110. Here the mobile device 130 uses local identifiers.

The main advantage of this architecture is that the physical connection between the mobile device 130 and the local terminal 110 enables the user potentially to synchronize their data with all the data contained in the local terminal 110, including any archived data.

The main disadvantage is that the data cannot be synchronized in real time with data stored in the server 120 when the user is away from their own local terminal 110.

Thus with the solutions available at present, the user must choose between having all the data available but with no real-time synchronization facility or to have only some of the data available but with a real-time synchronization facility.

Solutions for real-time synchronization between the local terminal and the remote mobile device exist but generally come with security problems and most businesses prohibit the use of these solutions.

This type of solution is installed on the local terminal and opens a communication port accessible from the outside to encapsulate the serial traffic in a network link. This amounts to a dematerialized direct USB link between the local terminal and the mobile device, which brings serious security weaknesses.

Moreover, this type of solution requires the local terminal to remain switched on with local proprietary software running continuously, which causes problems with maintenance of the local terminal such as difficulty in backing it up or updating it. At present, there are no secure solutions that make all the data available even when away from the local personal computer and that enable real-time synchronization.

One problem that makes direct synchronization with the server and the local terminal impossible is precisely this use of two types of data identifier.

### OBJECT AND SUMMARY OF THE INVENTION

The main object of the present invention is therefore to alleviate the drawbacks of the prior art methods by proposing a method of synchronizing data stored in a mobile device able to store data and to use it with proprietary client software, with data stored in a local terminal for the requirements of local software, in which local terminal it is identified by local identifiers, and with data stored in a server in which the data is associated with two types of identifier: local identifiers and network identifiers, the local terminal and the server being able to communicate to synchronize data stored in the local terminal with data stored in the server using the local identifiers, the method comprising the following steps:
detecting a connection;
when a connection is detected, determining whether that connection is or is not a connection to the local terminal;
if the connection is a connection to the local terminal, synchronizing data stored in the mobile device with data stored in the local terminal with their associated local identifiers, the proprietary client software using these local identifiers; and
if the connection is not a connection to the local terminal, performing the following steps:
   testing for the presence of a connection to the server;
   if a connection to the server is available, the mobile device sending the server local identifiers of data stored in the mobile device and a request to search for data on the server associated with these local identifiers;
   the mobile device receiving the result of the search comprising the network identifiers associated with the local identifiers sent; and
   synchronizing, at the command of the mobile device, the data stored in the mobile device with the data stored on the server on the basis of the network identifiers received.

The invention makes synchronization possible by correlating the identifiers. Interrogating the server using the returned network identifiers makes it possible to perform standard synchronization by scanning data in the server and comparing it with that in the mobile device. Data identified as having been modified or added is sent to the mobile device.

With such a method, it is possible for the greatest amounts of data, for example data including archived data, to be synchronized with the local terminal using the local identifiers and for the mobile device to be able to synchronize all its data directly with the server, which sends back only recently modified data.

Note that synchronization remains at the initiative and under the control of the proprietary client software. The server merely provides access to the data and the search function. For any device not provided with the local software, such access using the network protocol, in which only the network identifiers may be used, is possible. The network protocol is the generic protocol accessible by software other than the local software.

Note further that, according to the invention, synchronization is never effected by connecting to the local terminal and to the server at the same time. In contrast, the invention makes it possible to go from one synchronization mode to the other for the same configuration of synchronization options or, in other words, for the same synchronization profile. This change from one synchronization mode to the other is effected as a function of the available connection resources.

According to one advantageous feature of the invention, the search request uses a generic search function offered by the server for finding elements as a function of criteria chosen by the user and in particular making it possible to perform a search as a function of the local identifiers used by the local software.

Here the invention exploits characteristics generally seen in search functions offered by the server.

Such a generic search function is generally used to search for a particular element, for example a message from a particular sender. However, such generic search functions are also able to search for elements as a function of criteria other than a sender name and to return elements relating to diverse criteria that may be chosen by the user.

The invention utilizes a generic search function executed in the server and able to effect a search as a function of the local identifiers used by the local software in the local terminal and by the mobile device to store data synchronized with the local terminal.

According to one particular feature, the mobile device requiring a connection to a terminal in order to function, it uses the resources for connecting to the server of the terminal to which it is connected to communicate with the server.

This feature allows direct synchronization with the server via a connection using the connection resources of any terminal. The invention makes it possible to communicate with the server and to synchronize data stored in the mobile device from any terminal without requiring the installation of any application in the terminal in question or the local terminal. In particular, with the invention, no software for encapsulating the data in a link mimicking a USB link between the local terminal and the mobile device is installed in the terminal. This totally avoids the security weaknesses encountered until now. The invention makes it possible to use only the simple connection resources of the terminal to communicate with the server using the novel synchronization method of the invention.

This feature also makes it possible for a mobile device connected to the local terminal to synchronize its data directly with the server even though the local terminal to which it is connected has not yet synchronized all its data with all the data in the server.

The invention also provides a mobile device able to synchronize data stored in it for use with proprietary client software with data stored in a local terminal for the requirements of local software, in which local terminal it is identified by local identifiers, and with data stored on a server in which the data is associated with two types of identifier: local identifiers and network identifiers, the local terminal and the server being able to communicate to synchronize data stored in the local terminal with data stored in the server using the local identifiers, the device comprising the following means:
means for detecting a connection;
determination means for determining whether that connection is or is not a connection to the local terminal, these means being activated when a connection is detected;
means for synchronizing data stored in the mobile device with data stored in the local terminal with the associated local identifiers, the proprietary client software using these local identifiers, these synchronization means being adapted to operate if the connection is a connection to the local terminal;
means for testing for the presence of a connection to the server;
means for sending the server the local identifiers of data stored in the mobile device and a request to search for data on the server associated with these local identifiers, these means being adapted to operate if a connection to the server is available;
means for receiving the result of the search comprising the network identifiers associated with the local identifiers sent; and
means for synchronizing data on the basis of the network identifiers received.

The synchronization means make it possible to interrogate the server using the received network identifiers to determine data in the server recently modified or added.

The data modified or added, referred to as synchronization data and selected by the synchronization means, is then returned by the server, the mobile device determining the synchronization to be effected on the basis of the network identifiers and by comparison with the data present in the server.

In a preferred implementation of the invention, the steps of the method of the invention are determined by computer program instructions.

Consequently, the invention further provides a computer program product on an information medium, which program may be executed in a computer, the program including instructions adapted to execute the steps of the method of the invention.

This program may use any programming language and take the form of source code, object code, or a code intermediate between source code and object code, such as a partially-compiled form, or any other desirable form.

The invention further provides a computer-readable information medium containing instructions of a computer program as referred to above.

The information medium may be any entity or device capable of storing the program. For example, the medium may include storage means, such as a ROM, for example a CD ROM or a micro-electronic circuit ROM, or magnetic storage means, for example a floppy disk, a hard disk, a flash memory, a USB key, etc.

The information medium may be a transmissible medium such as an electrical or optical signal, which may be routed via an electrical or optical cable, by radio or by other means. The program of the invention may in particular be downloaded over an Internet-type network.

Alternatively, the information medium may be an integrated circuit in which the program is incorporated, the circuit being adapted to execute the method in question or to be used in its execution.

### BRIEF DESCRIPTION OF THE DRAWINGS

Other features and advantages of the present invention emerge from the following description given with reference to the appended drawings, which show one non-limiting implementation of the present invention. In the drawings:

FIG. 1 represents the architecture of a first prior art method;

FIG. 2 represents the architecture of a second prior art method;

FIG. 3 represents diagrammatically the architecture of the method of the invention; and

FIG. 4 is a functional block diagram of the method of the invention.

### DETAILED DESCRIPTION OF AN IMPLEMENTATION OF THE INVENTION

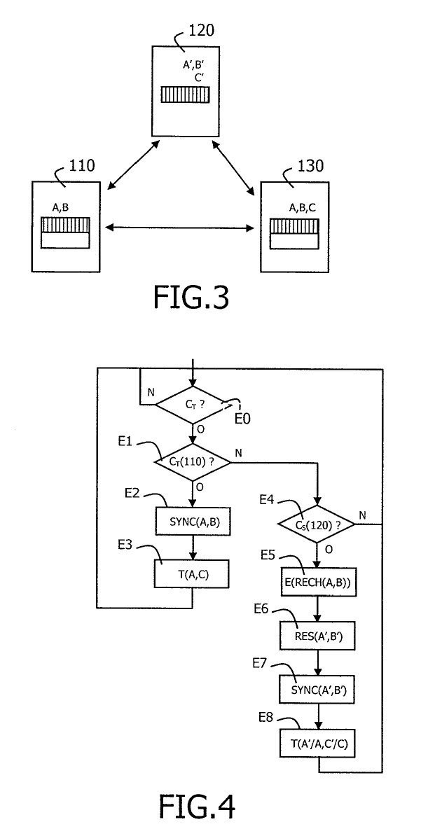

FIG. 3 is a diagram representing the architecture of the method of the invention. In this architecture, a mobile device 130 is able to connect to a local terminal 110 or a server 120. It is also able to use each of these connections to synchronize data stored in it.

During communication between the local terminal 110 and the server 120, as defined in the context of the invention, local identifiers are used. Furthermore, only local identifiers are used for storing data in the local terminal 110.

According to the invention, the local connection between the local terminal 110 and the mobile device 130 is used to synchronize data in the same manner as in FIG. 2. Thus, according to the invention, the mobile device 130 uses local identifiers in all the data stored in it and synchronizes with the local terminal 110 using the local identifiers.

Note here that the proprietary client software installed in the mobile device 130 is different from the local software used in the local terminal 110 but is able to use data identified by the same local identifiers as data used by the local software.

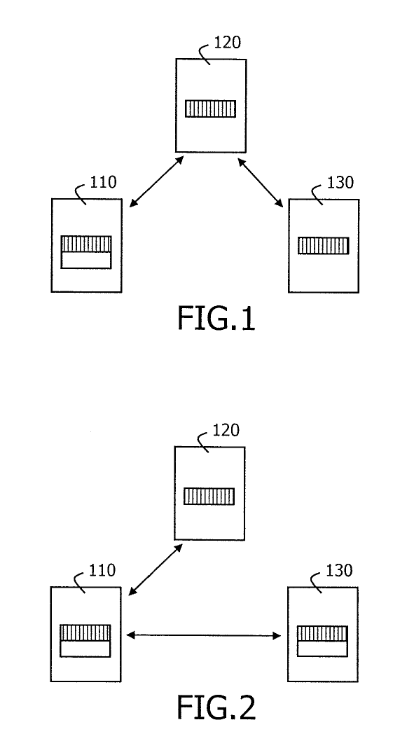

However, network identifiers are used during communication between the mobile device 130 and the server 120, whereas only local identifiers are used to store data in the mobile device 130. Consequently, it is not possible, for the purposes of synchronization, for the mobile device 130 to operate in the same manner as in the architecture represented in FIG. 1. In the context of the invention, the mobile device 130 uses local identifiers used in the local terminal 110 and not network identifiers that would enable it to synchronize directly with the server 120.

Here it is clear that, given that the proprietary client software uses local identifiers to identify data stored in it, it cannot dialogue with the server 120 in the manner represented in and described with reference to FIG. 1.

Accordingly, if A and B are the local identifiers of two elements stored in the local terminal 110 and in the mobile device 130, the corresponding network identifiers A′ and B′ are different.

FIG. 4 is a diagram representing a flowchart of the method of the invention.

In a first step E0, the mobile device 130 detects the presence of a connection C_{T} to a computer.

If such a connection C_{T} is detected, in a step E1 the mobile device 130 determines whether that connection C_{T} is a connection C_{T}(110) to the local terminal 110 of the user of the mobile device 130.

If the connection is a connection C_{T}(110) to the local terminal 110, in a step E2 the mobile device 130 synchronizes SYNC(A,B) the data using the local identifiers A, B. The mobile device 130 typically scans or sweeps the data stored in the local terminal and compares it to the data it stores itself. If there are differences between the contents of the data, for example that under the identifier A, or added data, for example data under an identifier C, the corresponding data is selected in order to send it to the mobile device 130.

The mobile device 130, which effects synchronization at its own initiative and under its own control, then, in a step E3, effects the transfer T(A,C) of synchronization data, here data under the identifiers A and C. This synchronization data generally comprises all the data, for example here all the data under the identifiers A and C.

If the connection detected is not a connection C_{T}(110) to the terminal 110, in a step E4 the mobile device 130 tests for the presence of a connection to the server C_{S}(120).

If a connection C_{S}(120) to the server 120 is detected, in a step E5 the mobile device 130 sends the server 120 a search request E(RECH(A,B)) in the names of the local identifiers A, B it uses itself.

The mobile device 130 receives in return the search result RES(A′,B′) that comprises the network identifiers A′, B′ corresponding to the local identifiers A, B.

In a step E7, the mobile device 130 synchronizes SYNC(A′,B′) its data on the basis of the received network identifiers A′,B′. Because the mobile device 130 knows the conversion between the network identifiers A′,B′ and the local identifiers A,B, it commands synchronization as a function of the data stored in it under the identifiers A and B by scanning and comparing that data to the data stored in the server 120 under the corresponding identifiers A′ and B′. This also enables it to detect modified data under those identifiers and to detect new identifiers and identifiers that have disappeared.

This makes it possible to synchronize only the new part of the data, typically new electronic messages, to be sent to the mobile device 130. In this mode of synchronization with the server 120, typically not all the data under an identifier is transferred if any data has been modified. For example, the mobile device 130 then detects modifications to the data in the server 120 under the identifier A′ and added data under new identifiers C/C′.

In a step E8, the mobile device 130 effects the transfer T(A′/A,C′/C) of synchronization data relating to the network identifiers A′ and C′. Note here that the synchronization processing performed by the mobile device 130 is typically such that it scans the data stored in the server 120 and selects in the data under a given identifier only data that has been modified, added or deleted. The synchronization data returned under the identifier A′ is then stored in the data set identified by the local identifier A and the synchronization data sent under the network identifier C′ is stored as a data set identified in the mobile device 130 by the local identifier C also supplied by the server during synchronization. Just as the functions of access to the data stored in the server can be effected only using the network identifiers, the network and local identifiers are restored by the access function in the result of the access request. The server 120 sends the identifiers A′/A and C′/C to the mobile device 130 with the data during synchronization.

During the step E5, to convert the local identifier A into the server identifier A′, the mobile device 130 advantageously calls on a generic search function offered as standard by the server 120.

Such a generic search function makes it possible to find elements, for example electronic messages, files, etc. as a function of a criterion chosen by the user.

Usually, such a search is effected in accordance with standard criteria of the type “search for electronic messages sent by X” or “search for to-do tasks not yet done”.

This type of search can be used by the proprietary client software installed in the mobile device 130, for example by a proprietary messaging client.

Thus the invention uses this generic search function to effect a search of the type “search for elements corresponding to identifier A”, in which case the server 120 returns the identifier A′.

The server 120 therefore makes it possible to effect the translation between the two identifiers via the remote or network protocol. In this way the mobile device 130 is informed of the conversion from A to A′.

It is then in a position to request synchronization of the elements corresponding to the identifier A′ of the server 120. By scanning the data under the identifier A′, the mobile device 130 detects data that has been modified or added under that identifier, for example a new electronic message in the mailbox.

If a new file is detected, identified by the identifiers C/C′ automatically assigned by the server 120 at the time of its creation, which corresponds to a new element that has reached the server, for example a new message, the mobile device 130 then recovers the local identifier C and the server identifier C′ during recovery of synchronization data.

Thus it is possible for the mobile device 130 to recover the corresponding local identifier C assigned by the server.

Accordingly, if an element C/C′ reaches the server 120 and is synchronized by the proprietary client software in the mobile device 130, it is synchronized using the identifier C′ but stored in the mobile peripheral under the identifier C. Thus C will be synchronized correctly on the next synchronization.

In the worst case scenario, C is not yet synchronized with the local terminal 110. It will therefore be treated as deleted during synchronization with the local terminal 110 and then as a new element when C has been synchronized with the local terminal 110.

This situation is rare in practice, in any case, and no data is lost because C is recovered during the next synchronization.

The invention typically finds a highly-beneficial application in messaging software synchronization. Thus the Outlook software installed on a local terminal 110 knows only the local identifiers. Consequently, on local synchronization with the local terminal, the proprietary client software installed on the mobile device 130 uses local identifiers.

In accordance with the invention, when the mobile device 130 thereafter attempts to synchronize with the server 120, it causes the server 120 to translate the identifiers that it knows, i.e. it has the local identifiers A,B translated into network identifiers A′, B′ and then uses them to synchronize its data with that stored in the server.

The process is the same for all types of object manipulated and liable to be synchronized: electronic messages, contacts, to-do lists, notes, calendar, etc.

Note finally that various implementations may be produced within the principles of the invention.

What is claimed is:

1. A method of synchronizing data stored in a mobile device able to store data and to use it with proprietary client software, with data stored in a local terminal for the requirements of local software, in which local terminal it is identified by local identifiers, and with data stored in a server in which the data is associated with two types of identifier: local identifiers and network identifiers, the local terminal and the server being able to communicate to synchronize data stored in the local terminal with data stored in the server using the local identifiers, the method comprising the following steps:
detecting a connection;
when a connection is detected, determining if that connection is or is not a connection to the local terminal;
if the connection is a connection to the local terminal, synchronizing data stored in the mobile device with data stored in the local terminal with their associated local identifiers, the proprietary client software using these local identifiers; and
if the connection is not a connection to the local terminal, performing the following steps:
testing for the presence of a connection to the server;
if a connection to the server is available, the mobile device sending the server local identifiers of data stored in the mobile device and a request to search for data on the server associated with these local identifiers;
the mobile device receiving the result of the search comprising the network identifiers associated with the local identifiers sent; and
synchronizing, at the command of the mobile device, the data stored in the mobile device with the data stored on the server on the basis of the network identifiers received.

2. A method according to claim 1, wherein the search request uses a generic search function offered by the server for finding elements as a function of criteria chosen by the user and in particular making it possible to perform a search as a function of the local identifiers used by the local software.

3. A method according to claim 1, wherein, the mobile device requiring a connection to a terminal in order to function, it uses the resources for connecting to the server of the terminal to which it is connected to communicate with the server.

4. A mobile device able to synchronize data stored in it for use with proprietary client software with data stored in a local terminal for the requirements of local software, in which local terminal it is identified by local identifiers, and with data stored on a server in which the data is associated with two types of identifier: local identifiers and network identifiers, the local terminal and the server being able to communicate to synchronize data stored in the local terminal with data stored in the server using the local identifiers, the device comprising the following means:
means for detecting a connection;
determination means for determining whether that connection is or is not a connection to the local terminal, these means being activated when a connection is detected;
means for synchronizing data stored in the mobile device with data stored in the local terminal with the associated local identifiers, the proprietary client software using these local identifiers, these synchronization means being adapted to operate if the connection is a connection to the local terminal;
means for testing for the presence of a connection to the server;
means for sending the server the local identifiers of data stored in the mobile device and a request to search for data on the server associated with these local identifiers, these means being adapted to operate if a connection to the server is available;
means for receiving the result of the search comprising the network identifiers associated with the local identifiers sent; and
means for synchronizing data on the basis of the network identifiers received.

5. A computer program product including instructions for executing the steps of the method according to claim 1 when said program is executed by a computer.

6. A computer-readable storage medium storing a computer program comprising instructions for executing the steps of the method according to claim 1.
